(19) United States
(12) Patent Application Publication
(10) Pub. No.: US 2017/0188064 A1
(43) Pub. Date: Jun. 29, 2017

(54) HANDLING OF MULTIMEDIA CONTENT

(71) Applicant: TELEFONAKTIEBOLAGET LM ERICSSON (PUBL), Stockholm (SE)

(72) Inventor: Daniel LINDSTÖM, Luleå (SE)

(73) Assignee: Telefonaktiebolaget LM Ericsson (publ), Stockholm (SE)

(21) Appl. No.: 15/119,897

(22) PCT Filed: Feb. 20, 2014
(86) PCT No.: PCT/SE2014/050205

§ 371 Date: Aug. 18, 2016

(51) Int. Cl. H04N 21/2343; H04N 21/439; H04L 29/06; H04N 7/15

(52) U.S. Cl. CPC H04N 21/234309; H04N 7/152; H04N 21/4394; H04L 65/403; H04L 65/1066

(57) ABSTRACT

There is provided handling multimedia content. Clients participating in a multimedia communications session are identified. One of the clients is a primary client. A multimedia format handling routine is then performed. Encoded first multimedia content from the primary client is acquired. The first multimedia content is encoded using a first multimedia format. A first group of remaining clients of the clients 10a, 10b, 10c is determined. The first group of remaining clients uses any multimedia format that is different from the first multimedia format. The encoded first multimedia content is, for the first group of the remaining clients, provided in all multimedia formats used by the first group of the remaining clients. The provided first multimedia content is, for the first group of the remaining clients, provided towards the first group of the remaining clients in respective multimedia formats used by clients of the first group of the remaining clients.

### TECHNICAL FIELD

Embodiments presented herein relate to handling multimedia content, and particularly to a method, a controller device, a computer program, and a computer program product for handling multimedia content.

### BACKGROUND

In recent years, video conferencing has become an important tool of daily life. In the business environment, it enables a more effective collaboration between remote locations as well as the reduction of travelling costs. In the private environment, video conferencing makes possible a closer, more personal communication between people.

For video communication services, such as video conferencing, there may be a challenge to obtain good performance and capacity for a given communications protocol, its parameters and the physical environment in which the video communication service is deployed.

In a video communication service each user may have his/her own client device. There may be a large number of users, and thus client devices, participating in the video communication service. Each client device may generate large amounts of encoded multimedia content, such as encoded video and audio content. In general terms, multimedia refers to the combination of the different types of media (texts, fixed or animated images, drawings and graphs, audio, video) in a common numerical format, assembled together by a data-processing program, and made available to a user allowing their exploitation. Depending on configurations of the client device, the client device may prompt users to save received multimedia files to their hard drive or use a plug-in to display or execute the multimedia file, such as within the browser window/environment.

As the popularity of such video communication services increases and the number of participating client devices in each such video communication service also increases, one issue concerns how to efficiently handle multimedia content.

Further, there may be different multimedia formats which the client devices may support. Examples include, but are not limited to MPEG-2 (or H.222/H.262), H.263, H.264/MPEG-4 Part 10 (or AVC, Advanced Video Coding), G.711, G.719, and Opus. Additionally, within each format, there may be different settings to choose from such as resolution, frame rate, etc.

Commonly, multimedia content is handled by a controller device in a communications network through which multimedia content is directed. The controller device may thus receive multimedia in different multimedia formats and be requested to provide multimedia in different multimedia formats.

Hence, there is a need for efficient handling of multimedia content.

### SUMMARY

An object of embodiments herein is to provide efficient handling of multimedia content.

According to a first aspect there is presented a method for handling multimedia content. The method comprises identifying clients participating in a multimedia communications session, wherein one of the clients is a primary client. The method comprises performing a multimedia format handling routine. The multimedia format handling routine comprises acquiring encoded first multimedia content from the primary client encoded using a first multimedia format. The multimedia format handling routine comprises determining a first group of remaining clients of the clients using any multimedia format different from the first multimedia format. The multimedia format handling routine comprises, for the first group of the remaining clients, providing the encoded first multimedia content in all multimedia formats used by the first group of the remaining clients. The multimedia format handling routine comprises, for the first group of the remaining clients, forwarding the provided first multimedia content towards the first group of the remaining clients in respective multimedia formats used by clients of the first group of the remaining clients.

Advantageously this provides efficient handling of multimedia content.

Advantageously this handling of multimedia content requires multimedia content to be decoded a minimum number of times.

According to an embodiment the method is performed by at least one controller device.

According to a second aspect there is presented a controller device for handling multimedia content. The controller device comprises a processing unit and a computer readable storage medium. The computer readable storage medium comprises instructions executable by the processing unit. The controller device is operative to identify clients participating in a multimedia communications session, wherein one of the clients is a primary client. The controller device is operative to perform a multimedia format handling routine. The multimedia format handling routine comprises, for the first group of the remaining clients, providing the encoded first multimedia content in all multimedia formats used by the first group of the remaining clients. The multimedia format handling routine comprises, for the first group of the remaining clients, forwarding the provided first multimedia content towards the first group of the remaining clients in respective multimedia formats used by clients of the first group of the remaining clients.

According to a third aspect there is presented a computer program for handling multimedia content, the computer program comprising computer program code which, when run on a at last one processing unit, causes the at last one processing unit to perform a method according to the first aspect.

According to a fourth aspect there is presented a computer program product comprising a computer program according to the third aspect and a computer readable means on which the computer program is stored.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1a is a schematic diagram illustrating a video conferencing system according to embodiments;

FIG. 1b is a schematic diagram illustrating a controller device according to prior art;

FIG. 1c is a schematic diagram illustrating a controller device according to embodiments;

FIG. 2a is a schematic diagram showing functional units of a controller device according to an embodiment;

FIG. 2b is a schematic diagram showing functional modules of a controller device according to an embodiment;

FIG. 3 shows one example of a computer program product comprising computer readable means according to an embodiment; and

FIGS. 4 and 5 are flowcharts of methods according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

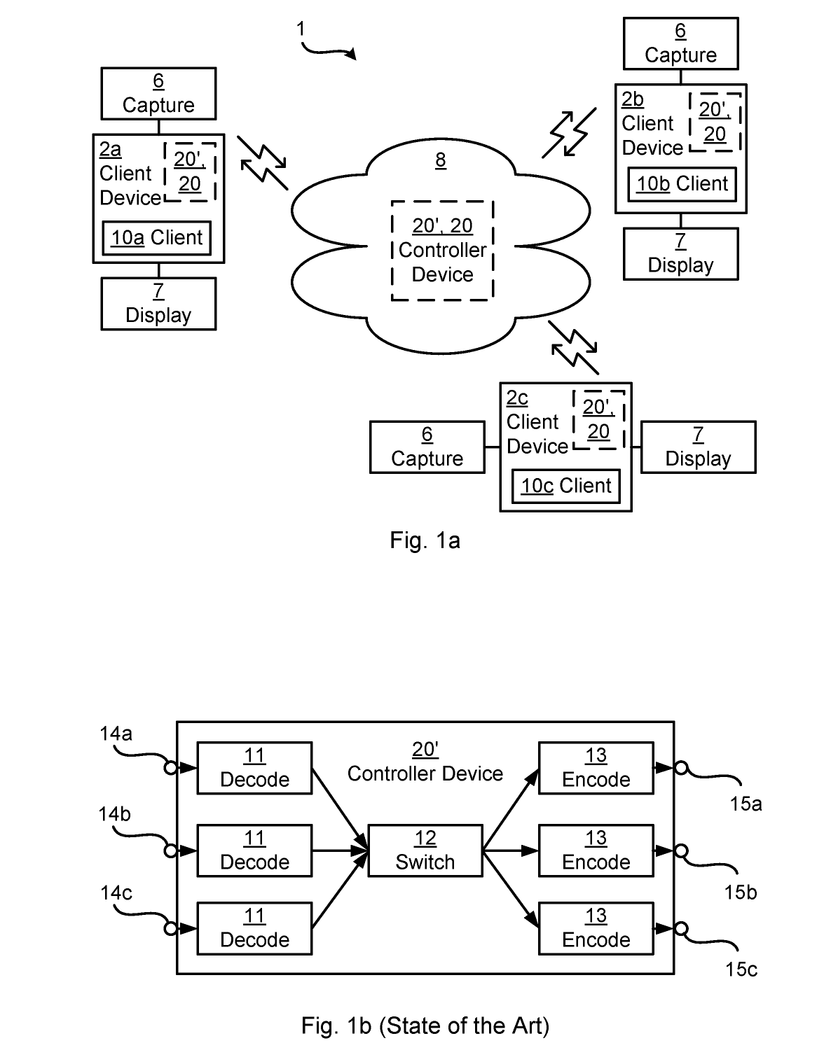

Consider the video conferencing system 1 illustrated in FIG. 1a. The video conferencing system 1 of FIG. 1a comprises a number of video conferencing client devices 2a, 2b, 2c. As the skilled person understands this is just an example of a video conferencing system where the disclosed embodiments apply. Thus, although only three client devices 2a, 2b, 2c are illustrated in FIG. 1a, there may in practical situations be a large combination of client devices 2a, 2b, 2c. The clients devices 2a, 2b, 2c are operatively connected via a communications network 8. Each client device 2a, 2b, 2c may comprise, or be operatively connected to, a capture unit 6 (i.e. one or more cameras for capturing a video stream) and a display unit 7 (i.e. a unit for rendering received video streams) that may require different video formats and thus be associated with different video encoders and decoders, respectively.

The communications network 8 comprises at least one controller device 20′, 20. The functionality of the at least one controller device 20′, 20 may be distributively implemented in the communications network 8. Alternatively, the at least one controller device 20′, 20 may be part of one of the client devices 2a, 2b, 2c. The at least one controller device 20′, 20 interacts with a client 10a, 10b, 10c provided in each client device 2a, 2b, 2c. The client 10a, 10b, 10c, may be a piece of video client software running in the client devices 2a, 2b, 2c and enabling the client devices 2a, 2b, 2c to communicate with other client devices 2a, 2b, 2c.

FIG. 1b schematically illustrates a controller device 20′according to prior art. The controller device 20′ of FIG. 1b comprises interfaces for receiving and providing encoded multimedia content. Particularly, the controller device 20′of FIG. 1b comprises a number of multimedia ports 14a, 14b, 14c for receiving encoded video content from the client devices 2a, 2b, 2c and a number of multimedia ports 15a, 15b, 15c for providing encoded video content to the client devices 2a, 2b, 2c. The number of multimedia ports 14a, 14b, 14c for receiving encoded video content may correspond to the number of client devices 2a, 2b, 2c from which encoded video content may be received. The multimedia content received at each multimedia port 14a, 14b, 14c is decoded by respective decoders 11 into a raw format. The decoded multimedia content (in raw format) is then provided to a central switch 12. In the central switch 12 the decoded multimedia content is switched towards intended recipients of the multimedia content. In general terms, the central switch 12 is arranged to only switch decoded multimedia content received from one multimedia port 14a, 14b, 14c at the time. After having been switched by the central switch 12 the decoded multimedia content (in raw format) is encoded by respective encoders 13 into formats used by the client devices 2a, 2b, 2c and then provided to the multimedia ports 15a, 15b, 15c. The number of multimedia ports 15a, 15b, 15c for providing encoded video content may correspond to the number of client devices 2a, 2b, 2c to which encoded video content may be provided. Hence, according to the controller device 20′of FIG. 1b, multimedia content from all client devices 2a, 2b, 2c is first decoded. One stream of decoded multimedia content is then encoded for each client device 2a, 2b, 2c.

The embodiments disclosed herein relate to handling of multimedia content. In order to handle multimedia content there is provided a controller device 20, a method performed by the controller device 20, a computer program comprising code, for example in the form of a computer program product, that when run on at least one processing unit, causes the at least one processing unit to perform the method.

FIG. 1c schematically illustrates a controller device 20 according to an embodiment. Similar to the controller device 20′ of FIG. 1b, the controller device 20 of FIG. 1c comprises interfaces for receiving and providing encoded multimedia content. Particularly, the controller device 20 of FIG. 1c comprises at least one multimedia port 14a, 14b, 14c for receiving encoded video content from at least one of the client devices 2a, 2b, 2c and a number of multimedia ports 15a, 15b, 15c, 15d for providing video content (encoded or in raw format) to the client devices 2a, 2b, 2c. The number of multimedia ports 14a, 14b, 14c for receiving encoded video content may correspond to the number of client devices 2a, 2b, 2c from which encoded video content may be received. Alternatively, there is a single multimedia port 14a for receiving encoded video content from one of the client devices 2a, 2b, 2c. Hence, the controller device 20 may be provided either as a central controller device 20 (e.g., receiving multimedia content from a plurality of client devices 2a, 2b, 2c) or as a local controller device 20 (e.g., receiving multimedia content from one of the client devices 2a, 2b, 2c).

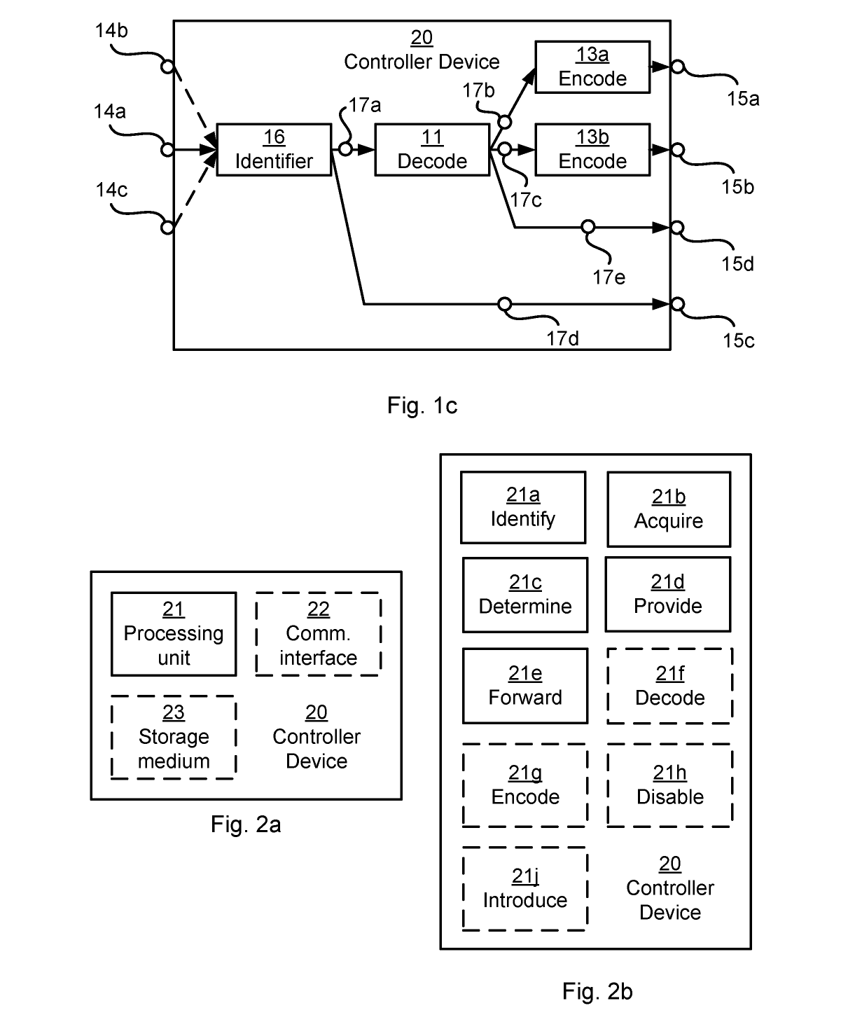

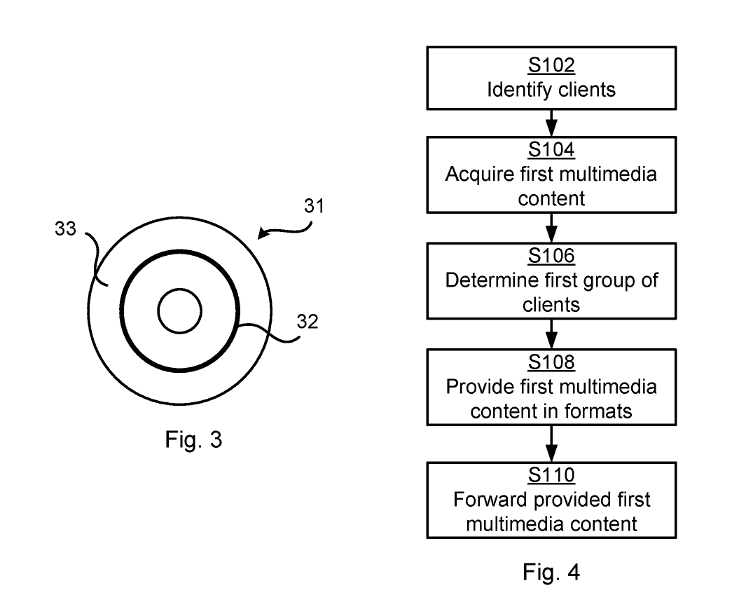

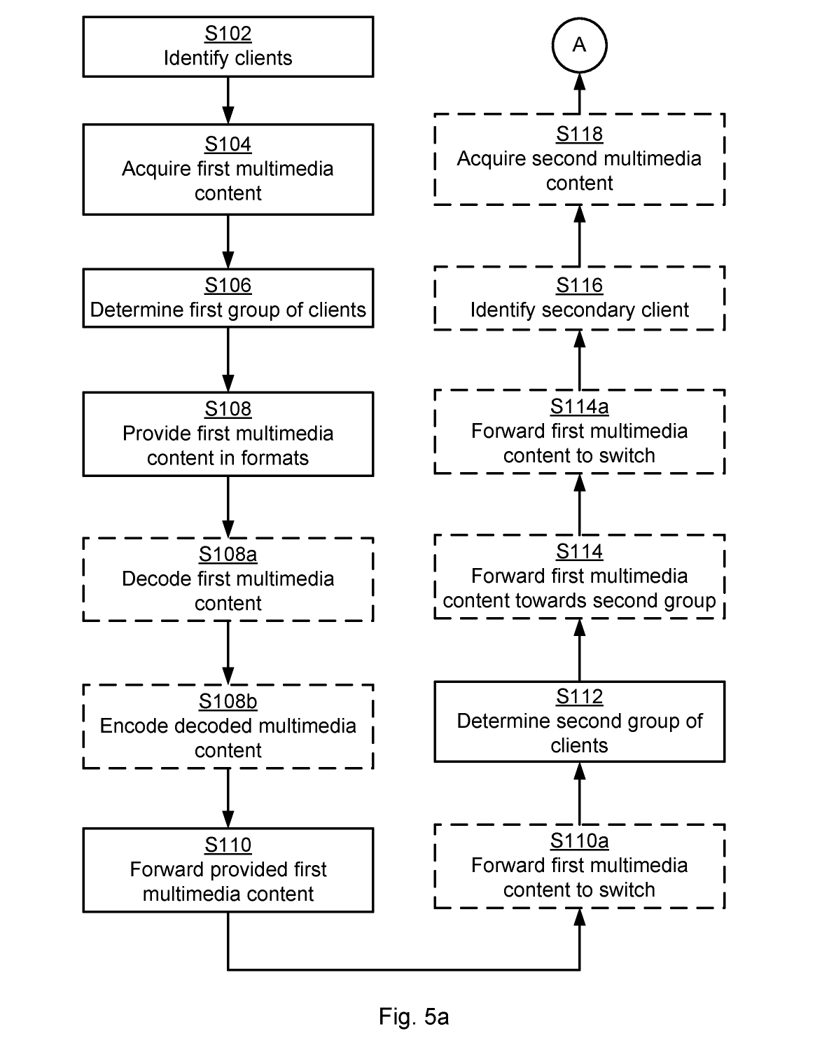

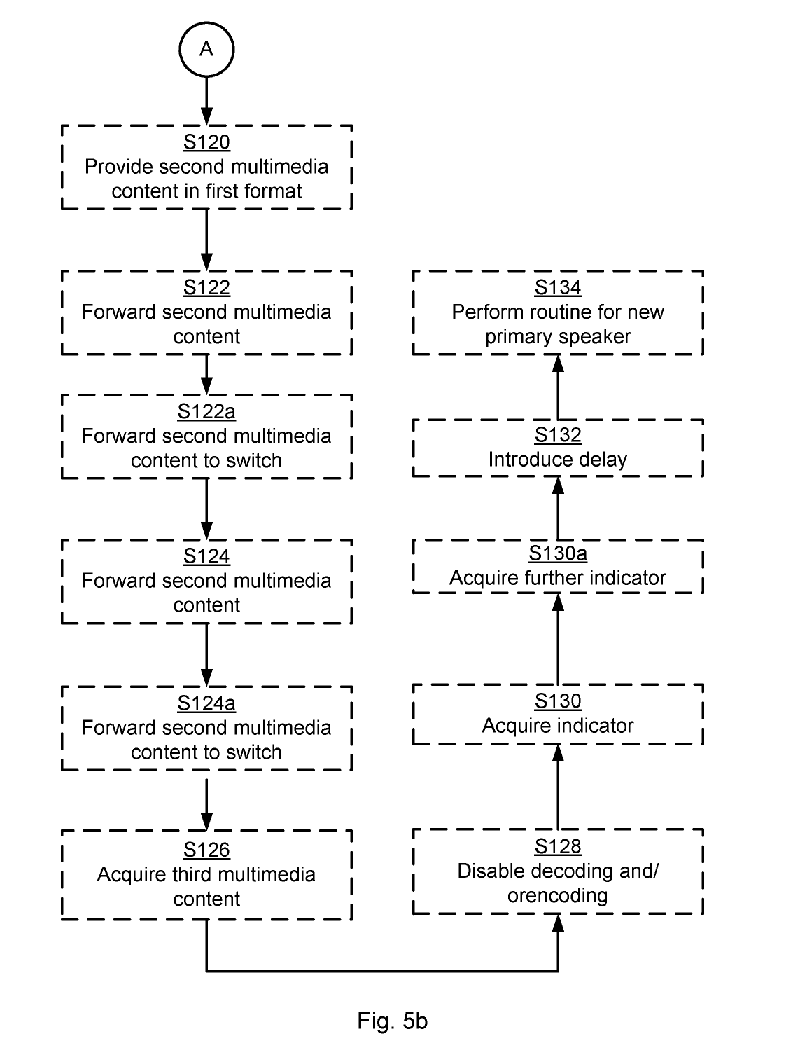

The multimedia content received at the multimedia ports 14a, 14b, 14c is provided to an identifier 16. The identifier 16 is configured to identify formats used to encode the received multimedia content and to identify one of clients 10a, 10b, 10c as a primary client. If multimedia content is received from only one of the client devices 2a, 2b, 2c, the identifier 16 may be configured to determine whether the client corresponding to said one of the client devices 2a, 2b, 2c is a primary client or not. Examples of how to identify the primary client will be provided below. Optionally, the identifier may be configured to identify also a secondary client. Examples of how to identify the secondary client will be provided below. Multimedia content of only the primary client or the secondary client is provided to decision gates 17a, 17d. The decision gates 17a, 17d (as well as decision gates 17b, 17c, 17e, see below) are configured to selectively either allow multimedia content to pass through or deny multimedia content to pass through. Examples of conditions for allowing or denying multimedia content to pass through a decision gate 17a, 17b, 17c, 17d, 17e will be provided below. Encoded multimedia content allowed to pass through decision gate 17a is decoded by the decoder 11. Decoding may involve de-packetizing received real-time protocol (RTP) frames of multimedia content. Hence only one stream of encoded multimedia content is decoded. Decoded multimedia content allowed to pass through decision gates 17b, 17c is encoded in respective formats by the encoders 13a and 13b, respectively before being forwarded to the multimedia ports 15a, 15b, 15c together with multimedia content (if any) allowed to pass through decision gate 17d. Encoding may involve packetizing the encoded multimedia content into real-time protocol (RTP) frames of multimedia content. Further, multimedia content may be provided in raw format to the multimedia port 15d by decoding the received multimedia content by the decoder ii and then passing the decoded multimedia content (in raw format) through the decision gate 17e. The multimedia content in raw format may also be packetized into RTP frames of multimedia content. Mechanisms for how handling of multimedia content, such as how to perform the operations of the identifier 16 and the decision gates 17a, 17b, 17c, 17d, 17e will be disclosed in detail below with references to FIGS. 4 and 5. FIG. 2a schematically illustrates, in terms of a number of functional units, the components of a controller device 20 according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 31a, 31b (as in FIG. 3), e.g. in the form of a storage medium 23. Thus the processing unit 21 is thereby arranged to execute methods as herein disclosed. The a storage medium 23 may also comprise persistent storage, which, for example, can be any single one or combination of magnetic memory, optical memory, solid state memory or even remotely mounted memory. The controller device 20 may further comprise a communications interface 22 for communications with client devices 2a, 2b, 2c and/or at least one further controller device 20. As such the communications interface 22 may comprise one or more transmitters and receivers, comprising analogue and digital components, a suitable number of antennas or wired ports. The processing unit 21 controls the general operation of the controller device 20 e.g. by sending data and control signals to the communications interface 22 and the storage medium 23, by receiving data and reports from the communications interface 22, and by retrieving data and instructions from the storage medium 23. Other components, as well as the related functionality, of the controller device 20 are omitted in order not to obscure the concepts presented herein.

FIG. 2b schematically illustrates, in terms of a number of functional modules, the components of a controller device 20 according to an embodiment. The controller device 20 of FIG. 2b comprises a number of functional modules; an identify module 21a, an acquire module 21b, a determine module 21c, a provide module 21d, and a forward module 21e. The controller device 20 of

FIG. 2b may further comprises a number of optional functional modules, such as any of a decode module 21f, and encode module 21g, a disable module 21h, and an introduce module 21j. The functionality of each functional module 21a-j will be further disclosed below in the context of which the functional modules may be used. In general terms, each functional module 21a-j may be implemented in hardware or in software. The processing unit 21 may thus be arranged to from the storage medium 23 fetch instructions as provided by a functional module 21a-j and to execute these instructions, thereby performing any steps as will be disclosed hereinafter.

The control device 20 may be provided as a standalone device or as a part of a further device. For example, the control device 20 may be provided in at least one of the client devices 2a, 2b, 2c. A video conferencing system 1 may comprise a controller device 20 and at least one client device 2a, 2b, 2c, each at least one client device hosting one of the clients 10a, 10b, 10c.

FIGS. 4 and 5 are flow charts illustrating embodiments of methods for handling multimedia content. The methods may be performed by at least one controller device 20. The methods are advantageously provided as computer programs 32. FIG. 3 shows one example of a computer program product 31 comprising computer readable means 33. On this computer readable means 33, a computer program 32 can be stored, which computer program 32 can cause the processing unit 21 and thereto operatively coupled entities and devices, such as the communications interface 22 and the storage medium 23 to execute methods according to embodiments described herein. The computer program 32 and/or computer program product 31 may thus provide means for performing any steps as herein disclosed.

In the example of FIG. 3, the computer program product 31 is illustrated as an optical disc, such as a CD (compact disc) or a DVD (digital versatile disc) or a Blu-Ray disc. The computer program product 31 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the computer program 32 is here schematically shown as a track on the depicted optical disk, the computer program 32 can be stored in any way which is suitable for the computer program product 31.

Reference is now made to FIG. 4 illustrating a method for handling multimedia content according to an embodiment. Parallel references are made to the controller device 20 of FIGS. 1c, 2a, and 2b.

S102: Clients 10a, 10b, 10c participating in a multimedia communications session are identified. One of the clients 10a, 10b, 10c is a primary client. Different considerations regarding how to identify the primary client will be disclosed below. The identification may be performed by performing operations of the identifier 16, the processing unit 21 and/or the identify module 21a.

A multimedia format handling routine is then performed. Details of the multimedia format handling routine will now be disclosed.

S104: Encoded first multimedia content from the primary client is acquired. The first multimedia content is encoded using a first multimedia format. The acquiring may be performed by performing operations of the identifier 16, the processing unit 21 and/or the acquire module 21b.

S106: A first group of remaining clients of the clients 10a, 10b, 10c is determined. The first group of remaining clients uses any multimedia format that is different from the first multimedia format. The determining may be performed by performing operations of the identifier 16, the processing unit 21 and/or the determine module 21c.

S108: The encoded first multimedia content is, for the first group of the remaining clients, provided in all multimedia formats used by the first group of the remaining clients. The providing may be performed by performing operations of the decoder ii, the decision gates 17b, 17c, the encoders 13a, 13b, the processing unit 21 and/or the provide module 21d.

S110: The provided first multimedia content is, for the first group of the remaining clients, provided towards the first group of the remaining clients in respective multimedia formats used by clients of the first group of the remaining clients. The providing may be performed by performing operations of the multimedia ports 15a, 15b, the processing unit 21 and/or the provide module 21d.

Reference is now made to FIGS. 5a and 5b illustrating methods for handling multimedia content according to further embodiments. Parallel references are continued to the controller device 20 of FIGS. 1c, 2a, and 2b.

The Re-encoded multimedia content may be forwarded to multimedia ports 15a, 15b. Thus, methods for handling multimedia content may comprise:

S110a: Forwarding the provided first multimedia content to a set of multimedia ports 15a, 15b. Each multimedia port 15a, 15b is associated with a respective one of the multimedia formats used by the first group of the remaining clients. The forwarding may be performed by performing operations of the encoders 13a, 13b, the processing unit 21 and/or the forward module 21e. The format used by the encoder 13a thus corresponds to the formats used by clients 10a, 10b, 10c operatively connected to the multimedia port 15a, and the format used by the encoder 13b thus corresponds to the formats used by clients 10a, 10b, 10c operatively connected to the multimedia port 15b.

Some further aspects of the format handling routine will now be described in turn.

According to an embodiment the encoded first multimedia content is not decoded for clients using the same format as the primary client. Hence, the format handling routine may comprise:

S112: Determining if there exists a second group of the remaining clients. The second group of the remaining clients comprises any remaining clients that are using the first multimedia format. The determining may be performed by performing operations of the identifier 16, the processing unit 21 and/or the determine module 21c.

If such a second group of the remaining clients has been identified the format handling routine may comprise:

S114: Forwarding the encoded first multimedia content from the primary client towards the second group of the remaining clients. The forwarding may be performed by performing operations of the decision gate 17d, the processing unit 21 and/or the forward module 21e.

The encoded first multimedia content may be forwarded to multimedia port 15c. Thus, methods for handling multimedia content may comprise:

S114a: Forwarding the encoded first multimedia content to a multimedia port 15c associated with the first multimedia format. The forwarding may be performed by performing operations of the decision gate 17d, the processing unit 21 and/or the forward module 21e. The format used by the primary client thus corresponds to the format used by clients 10a, 10b, 10c operatively connected to the multimedia port 15c.

There may be different ways to perform the providing as in S108. Different embodiments relating thereto will now be described in turn. The providing may involve decoding and encoding. Thus, first the encoded first multimedia content may be decoded into a raw format, and then the raw format version of the first multimedia content is encoded into respective formats used by the clients 10a, 10b, 10c (and which differ from the format of the primary client). Particularly, the providing in step S108 may comprise any of S108a and S108b:

S108a: Decoding the encoded first multimedia content into decoded first multimedia content in a raw format. The decoding may be performed by performing operations of the decoder 11, the processing unit 21 and/or the decode module 21f. Multimedia content in raw format may be passed through decision gate 17e to multimedia port 15d in case at least one of the clients 10a, 10b, 10c requests multimedia content in raw format.

S108b: encoding the first multimedia content in the raw format into the first multimedia content in all multimedia formats used by the first group of the remaining clients. The encoding may be performed by performing operations of the encoders 13a, 13b, the processing unit 21 and/or the encode module 21g. The encoding may comprise at least one of scaling, cropping, adjusting resolution, adjusting frame rate, adjusting bit rate, and transforming the first multimedia content. The encoding may comprise encoding the first multimedia content into encoded multimedia using at least one of MPEG-2 (or H.222/H.262), H.263, H.264/MPEG-4 Part 10 (or AVC, Advanced Video Coding), G.711, G.719, and Opus multimedia formats

As noted above, there may be a secondary client. Different aspects relating thereto will now be described in turn. Particularly, methods for handling multimedia content may comprise:

S116: Identifying one of the remaining clients as a secondary client. The identification may be performed by performing operations of the identifier 16, the processing unit 21 and/or the identify module 21a.

Additional further aspects of the format handling routine will now be described in turn.

S118: Encoded second multimedia content from the secondary client is acquired. The second multimedia content is encoded using a second multimedia format. The acquiring may be performed by performing operations of the identifier 16, the processing unit 21 and/or the acquire module 21b.

It is then checked if the second multimedia format differs from the first multimedia format. If these formats differ, the format handling routine involves:

S120: Providing the encoded second multimedia content as second multimedia content in the first multimedia format. The providing may be performed by performing operations of the encoders 13a, 13b, the processing unit 21 and/or the provide module 21d.

S122: Forwarding the second multimedia content in the first multimedia format towards the primary client. The forwarding may be performed by performing operations of the multimedia ports 15a, 15b, the processing unit 21 and/or the forward module 21e.

If these formats do not differ (i.e., if the second multimedia format is equal to the first multimedia format), the format handling routine involves:

S124: Forwarding the encoded second multimedia content from the secondary client towards the primary client. The forwarding may be performed by performing operations of the decision gate 17d, the processing unit 21 and/or the forward module 21e.

There may be different ways to forward the (encoded) second multimedia content from the secondary client towards the primary client as in S122 or S124. Different aspects relating thereto will now be described in turn.

The forwarding in S122 may further comprise:

S122a: Forwarding the second multimedia content in the first multimedia format to a multimedia port 15a, 15b associated with the first multimedia format. The forwarding may be performed by performing operations of one of the encoders 13a, 13b, the processing unit 21 and/or the forward module 21e.

The forwarding in S124 may further comprise:

S124a: Forwarding the encoded second multimedia content to a multimedia port 15c associated with the first multimedia format. The forwarding may be performed by performing operations of the decision gate 17d, the processing unit 21 and/or the forward module 21e.

There may be different ways to handle multimedia content provided by any of the remaining clients not being identified as a primary or a secondary client.

Different aspects relating thereto will now be described in turn. For example, it may be determined not to decode encoded multimedia content from any of the clients except the primary client and the secondary client. Thus, methods for handling multimedia content may comprise:

S126: Acquiring encoded third multimedia content from at least one of the remaining clients 10a, 10b, 10c not being identified as a secondary client. The acquiring may be performed by performing operations of the identifier 16, the processing unit 21 and/or the acquire module 21b.

Decoding and/or encoding of the third multimedia content may then be disabled. Thus, methods for handling multimedia content may comprise:

S128: Disabling at least one of decoding of the encoded third multimedia content and encoding of any already decoded third multimedia content. The disabling may be performed by performing operations of the identifier 16, the decision gates 17a, 17b, 17c, 17d, the decoder ii, the encoders 13a, 13b, the processing unit 21 and/or the disable module 21h.

The multimedia communications session may be part of a real-time video conference between the participating clients 10a, 10b, 10c. There may be different ways to identify the primary client. For example, the primary client may represent a current speaker of the real-time video conference. There may be different ways to identify the secondary client. For example, the secondary client may represent a most recent speaker of the real-time video conference. That is, the secondary client may represent the speaker being the most recently active speaker before the currently active speaker. There may be different ways to identify the current speaker. For example, identifying the primary client may comprise:

S130: Acquiring an indicator identifying the primary client. The acquiring may be performed by performing operations of the identifier 16, the processing unit 21 and/or the acquire module 21b. The indicator may be a voice activity detector (VAD) indicator. The VAD may be embedded in the multimedia content or be provided separately.

There may be different ways to determine if a new client should be the primary client. Different aspects relating thereto will now be described in turn. If a new client is determined as the primary client, the current primary client is determined as the new secondary client. The current secondary client is then regarded as one of the remaining clients. Thus, methods for handling multimedia content may comprise:

S130a: Acquiring a further indicator identifying another one of the clients as a new primary client. The acquiring may be performed by performing operations of the identifier 16, the processing unit 21 and/or the acquire module 21b.

The above disclosed multimedia format handling routine (as in S104, S106, S108, S110 and/or any variations thereof, such as S108a, S108b, S110a, or additions thereto, such as S112, S114, S114a) may then be performed, S134, for the new primary client acting as the primary client.

A time delay may be introduced before a new client is determined as the primary client. The time delay may be introduced so as not to corrupt any current processing of the multimedia content of the current primary client and/or multimedia content of the new primary client. Thus, methods for handling multimedia content may comprise:

S132: Introducing a time delay between acquiring the further indicator and performing the multimedia format handling routine. The introducing may be performed by performing operations of the identifier 16, the processing unit 21 and/or the introduce module 21j. The time delay may be dependent on at least one of the first multimedia format and a multimedia format used by the new primary client for encoding multimedia content. For example, the time delay may correspond to the time before a new independently encoded (I) frame of the new primary client is acquired.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for handling multimedia content, comprising;
identifying clients participating in a multimedia communications session, wherein one of said clients is a primary client; and
performing a multimedia format handling routine, wherein performing the multimedia format handling routine comprises:
acquiring encoded first multimedia content from said primary client encoded using a first multimedia format; and
determining a first group of remaining clients of said clients using any multimedia format different from said first multimedia format, and for said first group of said remaining clients;
providing said encoded first multimedia content in all multimedia formats used by said first group of said remaining clients; and
forwarding said provided first multimedia content towards said first group of said remaining clients in respective multimedia formats used by clients of said first group of said remaining clients.

2. The method according to claim 1, wherein performing said multimedia format handling routine further comprises:
determining that there exists a second group of said remaining clients using said first multimedia format; and
as a result of determining that there exists a second group of said remaining clients using said first multimedia format, forwarding said encoded first multimedia content from said primary client towards said second group of said remaining clients.

3. The method according to claim 1, wherein said forwarding further comprises:
forwarding said provided first multimedia content o a set of multimedia ports, each switch of which being associated with a respective one of the multimedia formats used by said first group of said remaining clients.

4. The method according to claim 2, wherein said forwarding further comprises:
forwarding said encoded first multimedia content to a multimedia port associated with said first multimedia format.

5. The method according to claim 1, wherein said providing comprises:
decoding said encoded first multimedia content into decoded first multimedia content in a raw format.

6. The method according to claim 5, wherein said providing further comprises:
encoding said first multimedia content in said raw format into said first multimedia content in said all multimedia formats used by said first group of said remaining clients.

7. The method according to claim 6, wherein said encoding comprises at least one of: scaling, cropping, adjusting resolution, adjusting frame rate, adjusting bit rate, and transforming said first multimedia content.

8. The method according to claim 1, further comprising;
identifying one of said remaining clients as a secondary client; and wherein performing said multimedia format handling routine further comprises:
acquiring encoded second multimedia content from said secondary client encoded using a second multimedia format;
if said second multimedia format differs from said first multimedia format:
providing said encoded second multimedia content as second multimedia content in said first multimedia format; and
forwarding said second multimedia content in said first multimedia format towards said primary client; and
if said second multimedia format is equal to said first multimedia format:
forwarding said encoded second multimedia content from said secondary client towards said primary client.

9. The method according to claim 8, wherein said forwarding said second multimedia content further comprises:
forwarding said second multimedia content in said first multimedia format to a multimedia port associated with said first multimedia format.

10. The method according to claim 8, wherein said forwarding said encoded second multimedia content further comprises:
forwarding said encoded second multimedia content to a multimedia port associated with said first multimedia format.

11. The method according to claim 1, said multimedia format handling routine further comprising:
acquiring encoded third multimedia content from at least one of said remaining clients not being identified as a secondary client; and
disabling at least one of decoding of said encoded third multimedia content and encoding of any already decoded third multimedia content.

12. The method according to claim 1, wherein said multimedia communications session is part of a real-time video conference between said participating clients.

13. The method according to claim 12, wherein said primary client represents a current speaker of said real-time video conference.

14. The method according to claim 8, wherein
said multimedia communications session is part of a real-time video conference between said participating clients, and
said secondary client represents a most recent speaker of said real-time video conference.

15. The method according to claim 1, wherein identifying said primary client comprises:
acquiring an indicator identifying said primary client.

16. The method according to claim 15, wherein said indicator is a voice activity detector indicator.

17. The method according to claim 15, further comprising:
acquiring a further indicator identifying another one of said clients as a new primary client; and
performing said multimedia format handling routine for said new primary client acting as said primary client.

18. The method according to claim 17, further comprising:
introducing a time delay between acquiring said further indicator and performing said multimedia format handling routine, wherein said time delay is dependent on at least one of said first multimedia format and a multimedia format used by said new primary client for encoding multimedia content.

19. The method according to claim 1, wherein the method is performed by at least one controller device.

20. A controller device for handling multimedia content, the controller device comprising a processing unit and a computer readable storage medium, said computer readable storage medium comprising instructions executable by said processing unit whereby said controller device is operative to:
identify clients participating in a multimedia communications session, wherein one of said clients is a primary client; and
perform a multimedia format handling routine, by:
acquiring encoded first multimedia content from said primary client encoded using a first multimedia format; and
determining a first group of remaining clients of said clients using any multimedia format different from said first multimedia format, and for said first group of said remaining clients:
providing said encoded first multimedia content in all multimedia formats used by said first group of said remaining clients; and
forwarding said provided first multimedia content towards said first group of said remaining clients in respective multimedia formats used by clients of said first group of said remaining clients.

21. A video conferencing system comprising a controller device according to claim 20.

22. A computer program product comprising a non-transitory computer readable medium storing a computer program for handling multimedia content, the computer program comprising computer program code which, when run on at least one processing unit, causes the at last one processing unit to:
identify clients participating in a multimedia communications session, wherein one of said clients is a primary client; and
perform a multimedia format handling routine, by:
acquiring encoded first multimedia content from said primary client encoded using a first multimedia format; and
determining a first group of remaining clients of said clients using any multimedia format different from said first multimedia format, and for said first group of said remaining Clients:
providing said encoded first multimedia content in all multimedia formats used by said first group of said remaining clients; and
forwarding said provided first multimedia content towards said first group of said remaining clients in respective multimedia formats used by clients of said first group of said remaining clients.

23. (canceled)
